(19) United States
(12) Patent Application Publication
(10) Pub. No.: US 2011/0052307 A1
(43) Pub. Date: Mar. 3, 2011

(54) TWO-IN-ONE SCREEN CLEANSING DEVICE

(75) Inventor: Jin-Sheng WENG, TAIPEI CITY (TW)

(73) Assignee: TAIWAN BOR YING CORPORATION, TAIPEI HSIEN (TW)

(21) Appl. No.: 12/868,750

(22) Filed: Aug. 26, 2010

(30) Foreign Application Priority Data
Sep. 1, 2009 (TW) 98216141

(51) Int. Cl. A47L 13/30; B43L 21/00; A47L 1/06

(52) U.S. Cl. 401/139; 15/245; 15/244.1

(57) ABSTRACT

A two-in-one screen cleansing device includes a holding body having a first and a second section connected to each other back to back, and the first and the second section defining a first and a second chamber, respectively; a cleansing fluid dispenser removably held in the first chamber; and a cleansing unit removably held in the second chamber. The cleansing fluid dispenser and the cleansing unit are held together as an integral body by the holding body 1 to avoid the risk of getting separated from each other easily to cause inconvenience to a user. The user can use the cleansing fluid contained in the cleansing fluid dispenser without the need of removing the cleansing fluid dispenser from the holding body.

### RELATED APPLICATIONS

This application claims priority to Taiwan Application Serial Number 98216141, filed Sep. 1, 2009, which is herein incorporated by reference.

### FIELD OF THE INVENTION

The present invention relates to a holding device, and more particularly to a two-in-one screen cleansing device that holds a cleansing fluid dispenser and a cleansing unit together as an integral body for cleansing a screen conveniently and efficiently.

### BACKGROUND OF THE INVENTION

Generally, a display screen, such as a television screen, a computer screen or a monitor screen, after being used for a period of time, would have dust, particles, or other impurities attached thereto due to electrostatic attraction. Smudges and grease might also attach to the screen due to contact of the user's hand with the screen. The dust, particles, impurities, smudges and grease attached to the screen would have adverse influence on the clarity of screen and the viewing quality.

The dust, particles, smudges or grease on the screen must be cleansed. To do so, cleansing fluid is usually used to enable effective cleansing.

In a conventional way of cleansing the screen, cleansing fluid is dispensed onto a piece of cleansing cloth and the cleansing cloth is then used to wipe the screen surface, in order to remove the dust and other smudges from the screen.

In the past, the cleansing fluid and the cleansing cloth for cleansing screen are usually separately positioned at different places. The user has to troublesomely locate them one by one for use. There are times the user could find the cleansing fluid but not the cleansing cloth or vice versa. Moreover, with the conventional cleansing cloth, it is not easy for the user to apply adequate and uniform force to wipe the screen; and, due to the uneven surface of the user's hand, the cleansing cloth handled by the user's hand might not be able to fully and uniformly contact with the screen. Under these conditions, it is uneasy to thoroughly cleanse the screen.

Due to the above-mentioned causes, the conventional screen cleansing elements, that is, the cleansing cloth and the cleansing fluid, has relatively poor applicability.

### SUMMARY OF THE INVENTION

A primary object of the present invention is to provide a two-in-one screen cleansing device that holds a cleansing fluid dispenser and a cleansing unit together as an integral body for cleansing a screen conveniently and efficiently.

Another object of the present invention is to provide a two-in-one screen cleansing device that can be easily operated to apply a uniform force on a screen to thoroughly clean the screen.

A further object of the present invention is to provide a two-in-one screen cleansing device that provides good applicability.

To achieve the above and other objects, the two-in-one screen cleansing device according to the present invention includes a holding body having a first section and a second section connected to each other back to back, and the first and the second section defining a first and a second chamber, respectively; a cleansing fluid dispenser removably held in the first chamber; and a cleansing unit removably held in the second chamber. The cleansing fluid dispenser and the cleansing unit are held together as an integral body by the holding body 1 to avoid the risk of getting separated from each other easily to bring inconvenience to a user.

In an embodiment of the present invention, the first section is provided on a position opposite to the second section with an axially extended opening communicating with the first chamber, so that the first section is given a degree of elasticity and can be slightly compressed or expanded at the opening, enable the cleansing fluid dispenser to be conveniently removed from or firmly held in the first chamber.

In an embodiment of the present invention, the first chamber has an inlet end and a support end axially opposite to each other, and the support end is provided with a through hole. The cleansing fluid dispenser is put in the first chamber via the inlet end and is supported on the support end. When it is desired to remove the cleansing fluid dispenser from the first chamber, a user needs only to push the cleansing fluid dispenser out of the chamber via the through hole.

In an embodiment of the present invention, the cleansing fluid dispenser has a spray nozzle projected beyond the inlet end of the first chamber. Therefore, a user can dispense the cleansing fluid contained in the cleansing fluid dispenser via the spray nozzle without the need of removing the cleansing fluid dispenser from the holding body.

In an embodiment of the present invention, the second section is provided at a position opposite to the first section with an access opening communicating with the second chamber. The user can conveniently put or remove the cleansing unit into or from the second chamber via the access opening.

According to another embodiment of the present invention, the cleansing unit includes a retaining portion as well as a grip portion and a cleansing portion separately located at two opposite ends of the retaining portion. A position on the second section of the holding body opposite to the first section is formed into a pair of clamping plates, so that a receiving space is defined in between the two clamping plates to communicate with the second chamber and receive the retaining portion of the cleansing unit therein. Therefore, the cleansing unit can be firmly clamped to the second section of the holding body or be removed from the second section for cleansing.

In an embodiment of the present invention, anti-slip grooves are correspondingly provided on two opposite outer surfaces of the retaining portion and on inner surfaces of the clamping plates to enable firm and stable engagement of the retaining portion 310 with the clamping plates, and accordingly connection of the cleansing unit to the second section.

According to a further embodiment of the present invention, the two-in-one screen cleansing device further includes a holding-down member provided with an internal stop and defining a window therein; and the second section is provided on a position opposite to the first section with a pair of clamping plates, so that a receiving space is defined in between the two clamping plates to communicate with the second chamber. The two clamping plates are respectively provided on one side facing away from the receiving space with a barb-shaped rib; the cleansing unit is held to the receiving space by the two clamping plates with a part of the cleansing unit extended beyond the clamping plates. The internal stop of the holding-down member is located corresponding to the two barb-shaped ribs for hooking thereto, so as to hold the cleansing unit down to the second section; and the part of the cleansing unit extended beyond the two clamping plates further extends through the window for cleansing the screen surface.

In an embodiment of the present invention, the two-in-one screen cleansing device further includes a protective cover removably closed onto an outer side of the holding-down member to shield and protect the cleansing unit against dust.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a two-in-one screen cleansing device according to a first embodiment of the present invention;

FIG. 2 is an exploded view of FIG. 1;

FIG. 3 is a top view of FIG. 1;

FIG. 4 is a sectional view taken along line A-A of FIG. 3;

FIG. 5 is an assembled perspective view of a two-in-one screen cleansing device according to a second embodiment of the present invention;

FIG. 6 is an exploded view of FIG. 5;

FIG. 7 is an assembled perspective view of a two-in-one screen cleansing device according to a third embodiment of the present invention with a protective cover separated therefrom; and

FIG. 8 is an exploded perspective view of FIG. 7.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

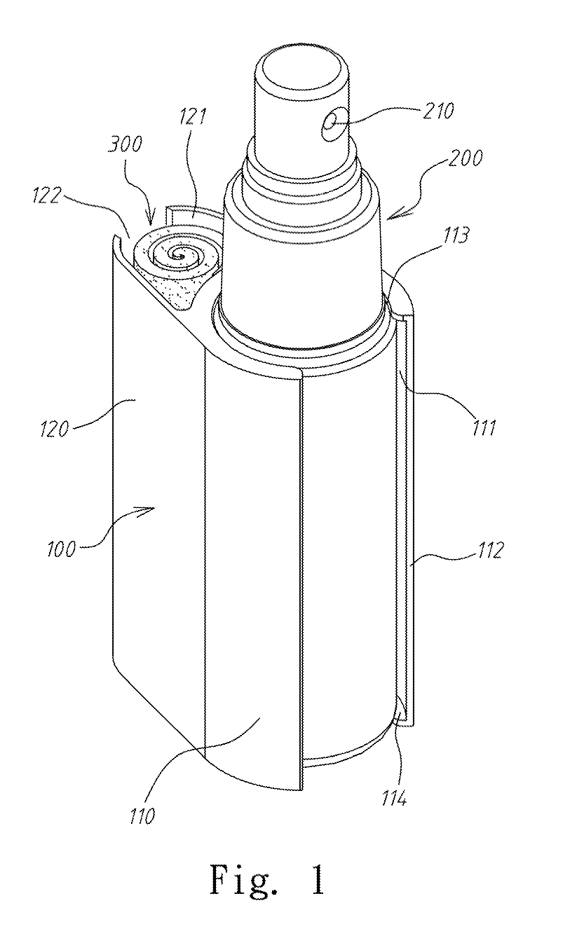

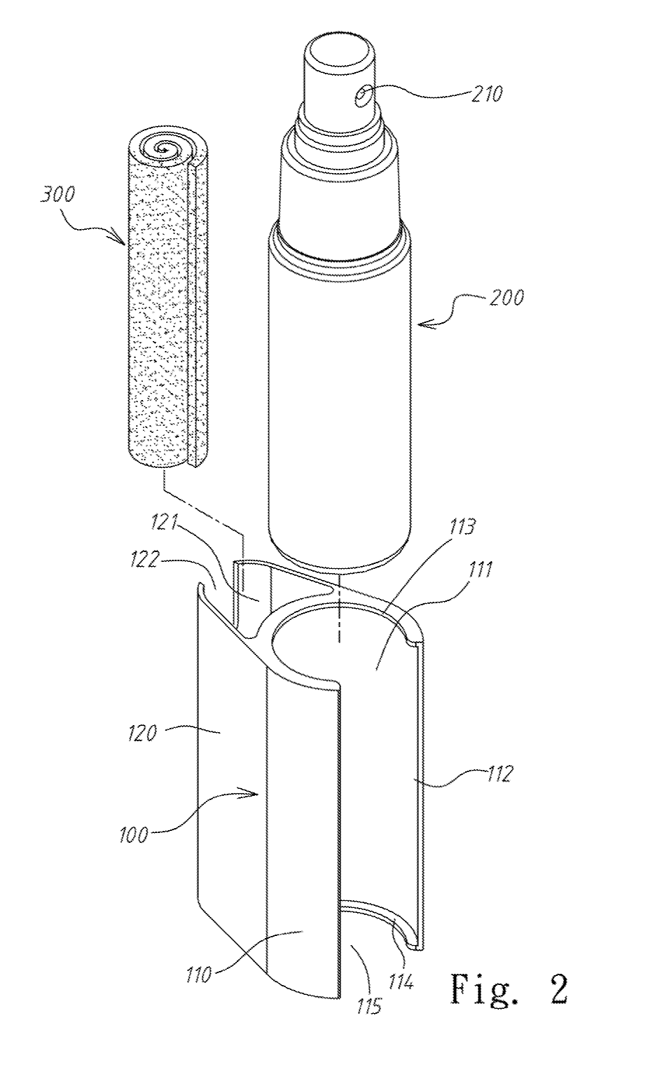

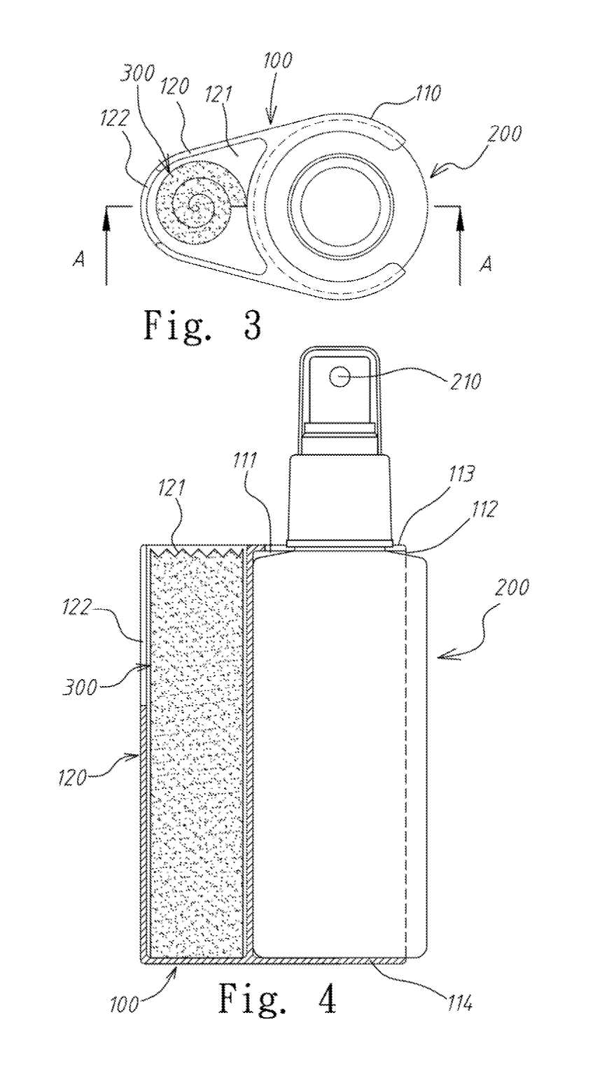

Please refer to FIGS. 1 to 4, in which a two-in-one screen cleansing device according to a first embodiment of the present invention is shown. As shown, the two-in-one screen cleansing device in the first embodiment includes a holding body 100, a cleansing fluid dispenser 200, and a cleansing unit 300.

The holding body 100 includes a first section 110 and a second section 120 that are connected to each other back to back. The first and the second section 110, 120 define a first and a second chamber 111, 121, respectively.

The first section 110 is formed at a position opposite to the second section 120 with an axially extended opening 112, which communicates with the first chamber 111 and gives the first section 110 a degree of elasticity, so that the first section 110 can be slightly compressed or expanded at the opening 112.

The cleansing fluid dispenser 200 serves to contain an amount of desired cleansing fluid therein, and is removably held in the first chamber 111 of the holding body 100. The first chamber 111 has an inlet end 113 and a support end 114 axially opposite to each other. The cleansing fluid dispenser 200 is put in the first chamber 111 via the inlet end 113, and is supported on the support end 114. Due to the elasticity of the first section 110, the cleansing fluid dispenser 200 can be firmly confined in the first chamber 111. In this manner, the cleansing fluid dispenser 200 can form an integral portion of the holding body 100 without the risk of undesirably separating therefrom. To enable convenient removal of the cleansing fluid dispenser 200 from the first chamber 111, the support end 114 is provided with a through hole 115. For example, when it is desired to remove the cleansing fluid dispenser 200 from the first chamber 111 to refill the dispenser 200 with the cleansing fluid, a user needs only to push the cleansing fluid dispenser 200 toward the inlet end 113 via the through hole 115, so that the cleansing fluid dispenser 200 can be easily removed from the first chamber 111.

The cleansing fluid dispenser 200 has a spray nozzle 210 projected beyond the inlet end 113 of the first chamber 111. Therefore, the cleansing fluid in the dispenser 200 can be dispensed via the spray nozzle 210 for use without the need of removing the whole cleansing fluid dispenser 200 from the holding body 100.

The cleansing unit 300 is removably held in the second chamber 121 of the holding body 100. The cleansing unit 300 can be a cleansing element of any type, such as a piece of cleansing cloth. To enable the user to conveniently put and remove the cleansing unit 300 into and from the second chamber 121, the second section 120 of the holding body 100 is provided at a position opposite to the first section 110 with an access opening 122 communicating with the second chamber 121. The user can conveniently put or remove the cleansing unit 300 into or from the second chamber 121 via the access opening 122 and a top opening of the second chamber 121.

To user the two-in-one screen cleansing device of the present invention to cleanse a surface of a display screen, the user needs only to remove the cleansing unit 300 from the second chamber 121 and spray the cleansing fluid (not shown) in the cleansing dispenser 200 via the spray nozzle 210 onto the cleansing unit 300 or the screen surface. Then, the user can wipe the screen surface with the cleansing unit 300 to clean dust or smudges from the screen surface. After the screen is cleansed, the user may replace the cleansing unit 300 into the second chamber 121 of the holding body 100. With the two-in-one screen cleansing device, the cleansing unit 300 and the cleansing fluid dispenser 200 can be simultaneously held to the holding body 100 without becoming easily separated from each other.

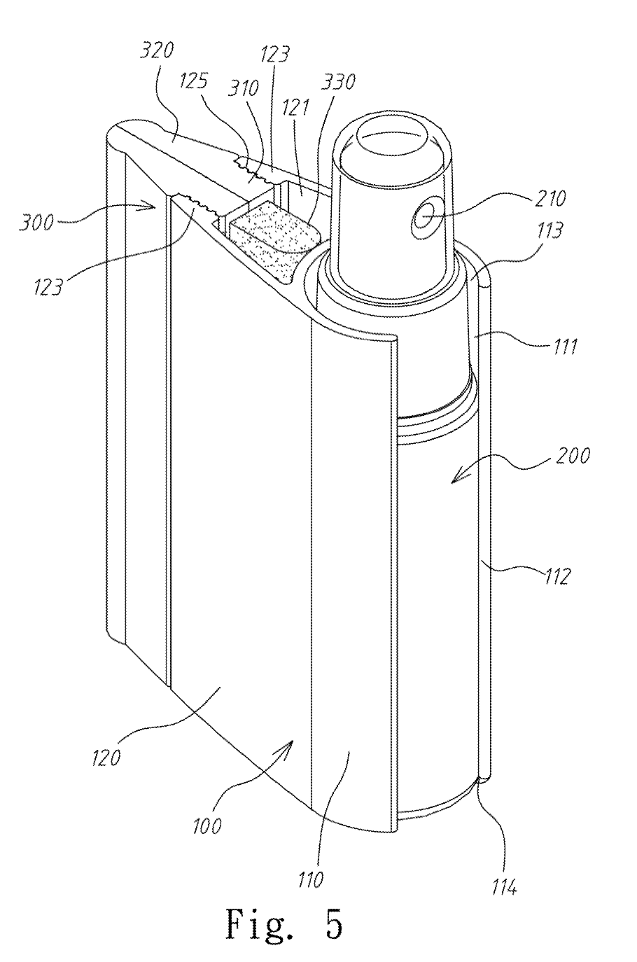

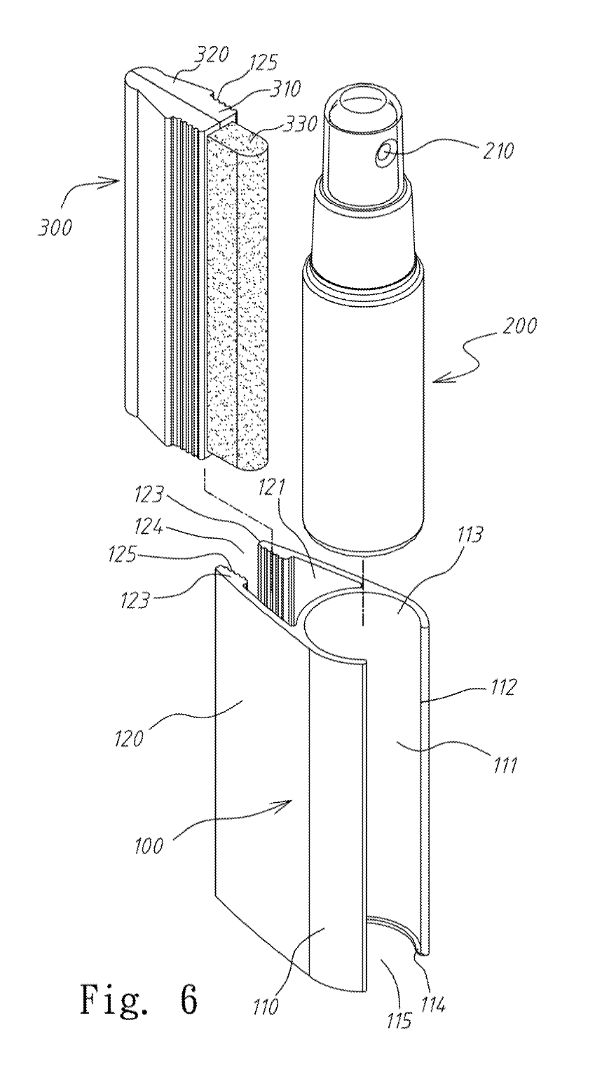

Please refer to FIGS. 5 and 6 that are assembled and exploded perspective views, respectively, of a two-in-one screen cleansing device according to a second embodiment of the present invention. The two-in-one screen cleansing device in the second embodiment also includes a holding body 100 having a first and a second section 110, 120, a cleansing fluid dispenser 200, and a cleansing unit 300. Since first section 110 of the holding body 100 and the cleansing fluid dispenser 200 in the second embodiment is structurally similar to those in the first embodiment, they are not described in details herein.

The cleansing unit 300 in the second embodiment includes a retaining portion 310 as well as a grip portion 320 and a cleansing portion 330 separately located at two opposite ends of the retaining portion 310. The cleansing portion 330 can be a cleansing element of any type, such as a cleansing sponge. A position on the second section 120 of the holding body 100 opposite to the first section 110 is formed into a pair of clamping plates 123, so that a receiving space 124 is defined in between the two clamping plates 123. The receiving space 124 communicates with the second chamber 121 and is adapted to receive the retaining portion 310 of the cleansing unit 300 therein. Anti-slip grooves 125 are correspondingly provided on two opposite outer surfaces of the retaining portion 310 and on inner surfaces of the clamping plates 123 to enable firm and stable engagement of the retaining portion 310 with the clamping plates 123, and accordingly connection of the cleansing unit 300 to the second section 120.

When the two-in-one screen cleansing device according to the second embodiment of the present invention is not in use, the cleansing unit 300 is held to the second section 120 of the holding body 100 with the cleansing portion 330 facing toward and received in the second chamber 121 and the retaining portion 310 located in the receiving space 124 and clamped by and between the two clamping plates 123, so that the cleansing portion 330 is shielded and protected from undesirable contamination by external dust.

When it is desired to use the two-in-one screen cleansing device of the present invention, first remove the cleansing unit 300 from the second chamber 121 of the second section 120, and then spray the cleansing fluid contained in the cleansing fluid dispenser 200 onto the cleansing portion 330 of the cleansing unit 300 or onto a display screen to be cleaned. Thereafter, the user may grip the cleansing unit 300 at the grip portion 320 and wipe the screen surface with the cleansing portion 330 to clean dust and smudges from the screen surface.

In the second embodiment of the present invention, the cleansing unit 300 and the cleansing fluid dispenser 200 are held together via the holding body 100 to avoid the risk of getting separated from each other easily. Moreover, the user can conveniently grip at the grip portion 320 to operate the cleansing portion 330 for cleansing the screen surface. Since the cleansing portion 330 can be designed to have a non-planar configuration that enables full and uniform contact of the cleansing portion 330 with the screen surface, a thorough and uniform cleansing effect can be obtained for the screen surface.

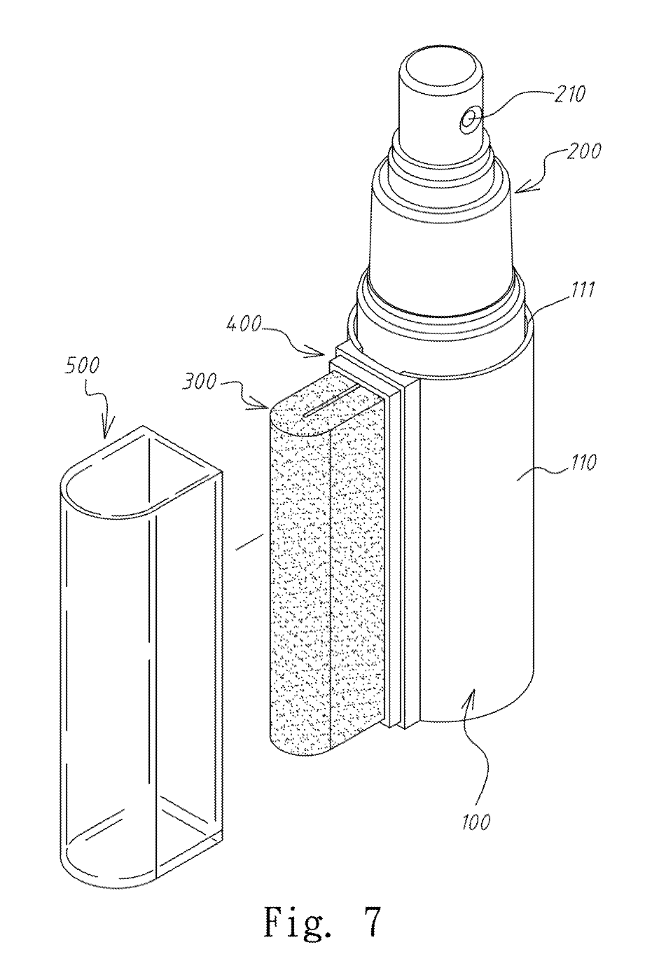

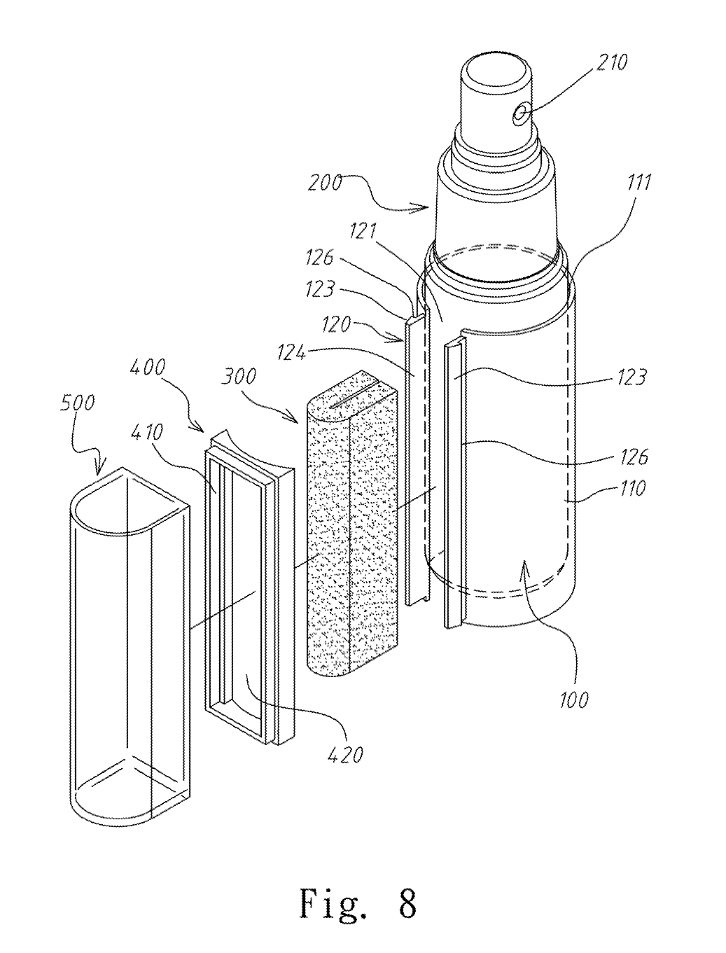

Please refer to FIGS. 7 and 8, in which a two-in-one screen cleansing device according to a third embodiment of the present invention is shown. The two-in-one screen device in the third embodiment includes a holding body 100 having a first and a second section 110, 120, a cleansing fluid dispenser 200, a cleansing unit 300, a holding-down member 400, and a protective cover 500. Since the first section 110 of the holding body 100 and the cleansing fluid dispenser 200 are structurally similar to those in the first embodiment, they are not described in details herein.

In the third embodiment, the second section 120 of the holding body 100 is provided on a position opposite to the first section 110 with a pair of clamping plates 123, so that a receiving space 124 is defined in between the two clamping plates 123 to communicate with the second chamber 121. The cleansing unit 300, such as a cleansing sponge, is held to the receiving space 124 by the two clamping plates 123 with a part of the cleansing unit 300 extended beyond the clamping plates 123. The two clamping plates 123 are respectively provided on one side facing away from the receiving space 124 with a barb-shaped rib 126.

The holding-down member 400 is provided with an internal stop 410 corresponding to the two barb-shaped ribs 126 for hooking thereto, so as to hold the cleansing unit 300 down to the second section 120. The holding-down member 400 defines a window 420 therein, so that the part of the cleansing unit 300 extended beyond the two clamping plates 123 further extends through the window 420 for cleansing a screen surface.

When the two-in-one screen cleansing device is not in use, the protective cover 500 is removably closed onto an outer side of the holding-down member 400 to cover and protect the cleansing unit 300 against undesirable contamination by external dust.

To use the two-in-one screen cleansing device, first remove the protective cover 500 from the second section 120, and then spray the cleansing fluid contained in the cleansing fluid dispenser 200 onto the screen surface to be cleaned. The first section 110 of the holding body 100 can serve as a handle for the user to grip at, so that the cleansing unit 300 can be manipulated to contact with and wipe the screen surface to clean dust and smudges from the screen surface.

In the third embodiment of the present invention, the cleansing unit 300 and the cleansing fluid dispenser 200 are held together via the holding body 100 to avoid the risk of getting separated from each other easily. Moreover, the user can conveniently grip at the first section 110 to operate the cleansing portion 330 for cleansing the screen surface. Since the cleansing unit 300 can be designed to have a non-planar configuration that enables full and uniform contact of the cleansing unit 300 with the screen surface, a thorough and uniform cleansing effect can be obtained for the screen surface.

With the two-in-one screen cleansing device of the present invention, a cleansing fluid dispenser and a cleansing unit can be held together as an integral body by the holding body 1 to avoid the risk of getting separated from each other easily to cause inconvenience to a user. Further, the two-in-one screen cleansing device can be conveniently gripped to apply a uniform force on the screen surface, so that a thorough cleansing effect can be obtained for the screen.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A two-in-one screen cleansing device for cleansing a screen surface, comprising:
a holding body having a first section and a second section connected to each other back to back; and the first section and the second section defining a first chamber and a second chamber, respectively;
a cleansing fluid dispenser being removably held in the first chamber; and
a cleansing unit being removably held in the second chamber.

2. The two-in-one screen cleansing device as claimed in claim 1, wherein the first section is provided on a position opposite to the second section with an axially extended opening, and the opening communicating with the first chamber.

3. The two-in-one screen cleansing device as claimed in claim 2, wherein the first chamber has an inlet end and a support end axially opposite to each other, and the support end being provided with a through hole.

4. The two-in-one screen cleansing device as claimed in claim 3, wherein the cleansing fluid dispenser has a spray nozzle projected beyond the inlet end of the first chamber.

5. The two-in-one screen cleansing device as claimed in claim 2, wherein the cleansing unit comprises a piece of cleansing cloth.

6. The two-in-one screen cleansing device as claimed in claim 5, wherein the second section is provided on a position opposite to the first section with an access opening, and the access opening communicating with the second chamber.

7. The two-in-one screen cleansing device as claimed in claim 2, wherein the cleansing unit includes a retaining portion as well as a grip portion and a cleansing portion separately located at two opposite ends of the retaining portion; a position on the second section of the holding body opposite to the first section being formed into a pair of clamping plates, so that a receiving space is defined in between the two clamping plates; and the receiving space communicating with the second chamber and being adapted to receive the retaining portion of the cleansing unit therein.

8. The two-in-one screen cleansing device as claimed in claim 7, wherein the retaining portion is provided on two opposite outer surfaces with a plurality of anti-slip grooves, and the two clamping plates are provided on respective inner surface with a plurality of anti-slip grooves corresponding to the anti-slip grooves on the retaining portion.

9. The two-in-one screen cleansing device as claimed in claim 8, wherein the cleansing portion comprises a cleansing sponge.

10. The two-in-one screen cleansing device as claimed in claim 2, further comprising a holding-down member provided with an internal stop and defining a window therein; and wherein the second section is provided on a position opposite to the first section with a pair of clamping plates, so that a receiving space is defined in between the two clamping plates to communicate with the second chamber; the two clamping plates being respectively provided on one side facing away from the receiving space with a barb-shaped rib; the cleansing unit being held to the receiving space by the two clamping plates with a part of the cleansing unit extended beyond the clamping plates; and wherein the internal stop of the holding-down member is located corresponding to the two barb-shaped ribs for hooking thereto, so as to hold the cleansing unit down to the second section; and wherein the part of the cleansing unit extended beyond the two clamping plates further extends through the window for cleansing the screen surface.

11. The two-in-one screen cleansing device as claimed in claim 10, wherein the cleansing unit comprises a cleansing sponge.

12. The two-in-one screen cleansing device as claimed in claim 10, further comprising a protective cover being removably closed onto an outer side of the holding-down member to protect the cleansing unit against dust and contamination.
